(19) United States
(12) Patent Application Publication
(10) Pub. No.: US 2020/0067251 A1
(43) Pub. Date: Feb. 27, 2020

(54) TERMINAL ASSEMBLY AND METHOD

(71) Applicant: Lear Corporation, Southfield, MI (US)

(72) Inventors: Brandon H. Dix, Livonia, MI (US); Salim A. Marouf, Ypsilanti, MI (US); Priyal N. Sheth, Dearborn, MI (US); Arindam Banerjee, Dearborn, MI (US); Sneha Agasthya, Dearborn, MI (US)

(21) Appl. No.: 16/107,578

(22) Filed: Aug. 21, 2018

(51) Int. Cl. H01R 43/048; H01R 4/18

(52) U.S. Cl. CPC H01R 43/048; H01R 43/042; H01R 4/184

(57) ABSTRACT

A method of assembling a terminal assembly includes providing a terminal having a terminal body, a first wing, and/or a second wing. The method may include removing an end portion of the first wing, and/or an end portion of the second wing to provide a shortened first wing and/or a shortened second wing. The method may include crimping the shortened first wing and/or the shortened second wing onto a wire. The end portion of the first wing and the end portion of the second wing may be removed simultaneously. The end portion of the first wing and/or the end portion of the second wing may be removed via a die.

### TECHNICAL FIELD

The present disclosure generally relates to terminals and terminal assemblies, including electrical terminals that may be used in connection with electrical wires or cables.

### BACKGROUND

This background description is set forth below for the purpose of providing context only. Therefore, any aspect of this background description, to the extent that it does not otherwise qualify as prior art, is neither expressly nor impliedly admitted as prior art against the instant disclosure.

Some terminal assemblies may be relatively complex to use and/or to assemble. For example, connecting a terminal with some electrical conductors may involve a complex process and may include many different steps and components. Some terminals may not be configured for use with conductors of different sizes, so different types of terminals may be used for various sizes of conductors.

There is a desire for solutions/options that minimize or eliminate one or more challenges or shortcomings of terminals, electrical terminals, and/or terminal assemblies. The foregoing discussion is intended only to illustrate examples of the present field and should not be taken as a disavowal of scope.

### SUMMARY

In embodiments, a method of assembling a terminal assembly may include providing a terminal. The terminal may include a terminal body, a first wing, and/or a second wing. The method may include removing an end portion of the first wing and an end portion of the second wing to provide a shortened first wing and a shortened second wing. The method may include crimping the shortened first wing and the shortened second wing onto a wire. The end portion of the first wing and the end portion of the second wing may be removed simultaneously. The end portion of the first wing and the end portion of the second wing may be removed via a die. The die may include a first protrusion that contacts an inner surface of the first wing during the removing and may include a second protrusion that contacts an inner surface of the second wing during the removing.

In embodiments, a method of assembling a terminal assembly may include removing an end portion of a third wing of a terminal and removing an end portion of a fourth wing of the terminal. The end portions of the first wing, the second wing, the third wing, and the fourth wing may be removed simultaneously. The third wing and the fourth wing may be longer than the first wing and the second wing. The method may include determining a size of the wire and/or determining lengths of the end portion of the first wing and the end portion of the second wing according to the size of the wire.

In embodiments, a method of assembling a terminal assembly may include providing a second terminal having a terminal body, a first wing, and a second wing; removing an end portion of the first wing of the second terminal to provide a shortened first wing of the second terminal; and/or removing an end portion of the second wing of the second terminal to provide a shortened second wing of the second terminal. Before the removing of the end portions of the first wing and the second wing of the terminal and before the removing of the end portions of the first wing and the second wing of the second terminal, the terminal and the second terminal may be substantially the same. Lengths of the shortened first wing and the shortened second wing of the terminal may be different than lengths of the shortened first wing and the shortened second wing of the second terminal. Lengths of the end portions of the first wing and the second wing of the terminal may be different than lengths of the end portions of the first wing and the second wing of the second terminal.

In embodiments, a method of assembling a terminal assembly may include crimping a shortened first wing and a shortened second wing of the second terminal onto a second wire. The second wire may include a different diameter than the wire. The method may include determining a size of a second wire and/or determining lengths of the end portions of the first wing and the second wing of the second terminal according to the size of the second wire. The end portion of the first wing and the end portion of the second wing may be removed via a first die. The first die may include a first portion and a second portion, and, during the removing, the first portion contacts the first wing and the second wing, and the second portion contacts a third wing and a fourth wing of the terminal. The first portion may be disposed at a different vertical height than the second portion. The shortened first wing and the shortened second wing may be crimped via a second die. The first die and the second die may include different configurations.

The foregoing and other aspects, features, details, utilities, and/or advantages of embodiments of the present disclosure will be apparent from reading the following description, and from reviewing the accompanying drawings.

### BRIEF DESCRIPTION OF THE DRAWINGS

FIG. 1A is a perspective view generally illustrating an embodiment of a terminal assembly.

FIG. 1B is a perspective view generally illustrating portions of an embodiment of a terminal.

FIG. 1C is a side view generally illustrating portions of an embodiment of a terminal.

FIG. 1D is a cross-sectional view generally illustrating an embodiment of a terminal.

FIG. 1E is a side view generally illustrating an embodiment of a terminal assembly.

FIG. 1F is a cross-sectional perspective view of a section generally illustrating an embodiment of a terminal assembly.

FIG. 2 is a flowchart generally illustrating an embodiment of a method of assembling a terminal assembly.

FIGS. 3A and 3B are cross-sectional views generally illustrating portions of embodiments of terminals and dies.

FIGS. 3C and 3D are side views generally illustrating portions of embodiments of terminals and dies.

FIG. 4A is a perspective view generally illustrating portions of an embodiment of a terminal assembly after removing end portions of wings of the terminal.

FIG. 4B is a perspective view generally illustrating portions of an embodiment of a terminal after removing end portions of wings of the terminal.

FIG. 4C is a top view generally illustrating portions of an embodiment of a terminal after removing end portions of wings of the terminal.

FIG. 4D is a side view generally illustrating portions of an embodiment of a terminal after removing end portions of wings of the terminal.

FIG. 4E is a cross-sectional view generally illustrating portions of an embodiment of a terminal after removing end portions of wings of the terminal.

FIG. 5A is a cross-sectional view generally illustrating portions of embodiments of a terminal and a die.

FIGS. 5B and 5C are side views generally illustrating portions of embodiments of a terminal assembly and a die.

FIG. 6A is a top view generally illustrating portions of an embodiment of a terminal assembly after crimping.

FIG. 6B is a cross-sectional view generally illustrating portions of an embodiment of a terminal assembly after crimping.

FIG. 6C is a perspective view generally illustrating portions of an embodiment of a terminal assembly after crimping.

FIGS. 7A, 7B, and 7C are cross-sectional views generally illustrating portions of embodiments of terminal assemblies after crimping.

### DETAILED DESCRIPTION

Reference will now be made in detail to embodiments of the present disclosure, examples of which are described herein and illustrated in the accompanying drawings. While the present disclosure will be described in conjunction with embodiments and/or examples, it will be understood that they are not intended to limit the present disclosure to these embodiments and/or examples. On the contrary, the present disclosure is intended to cover alternatives, modifications, and equivalents.

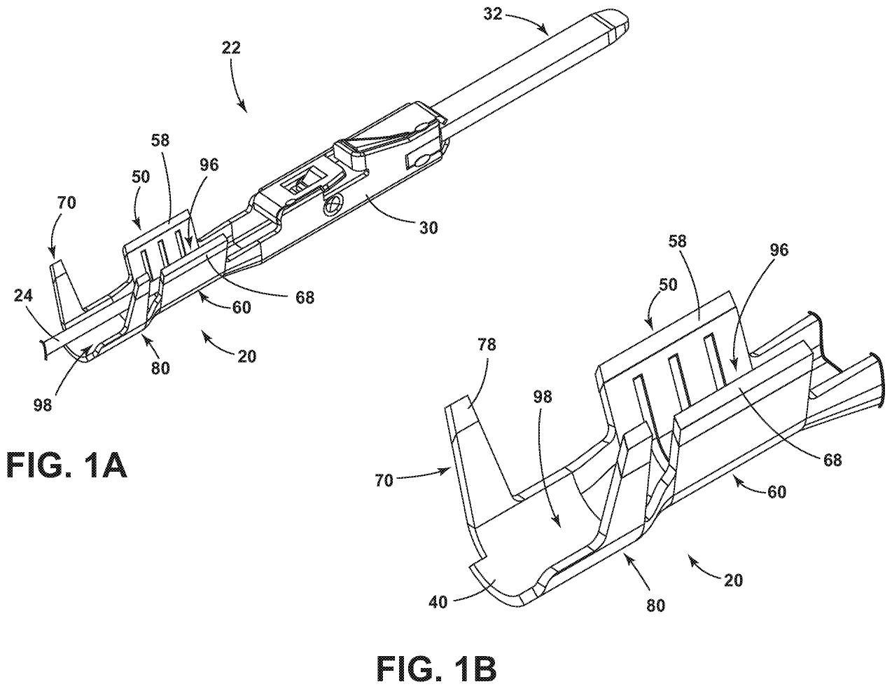

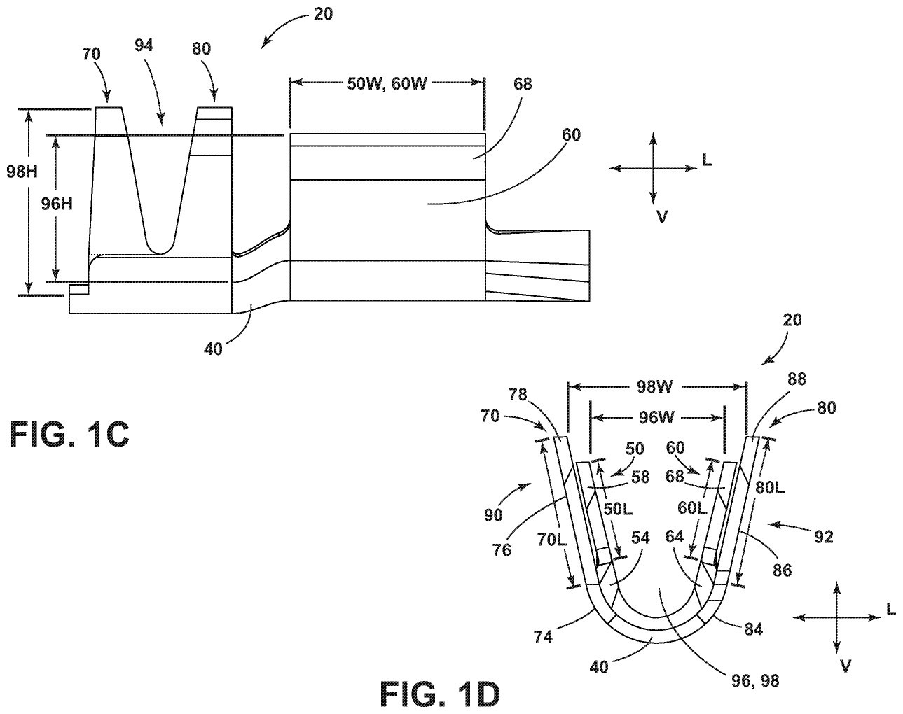

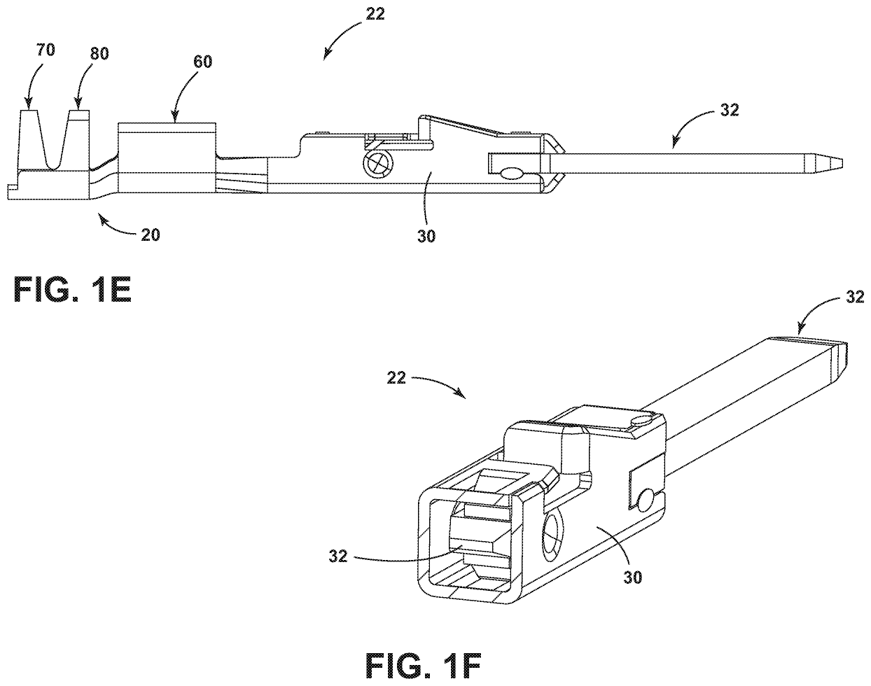

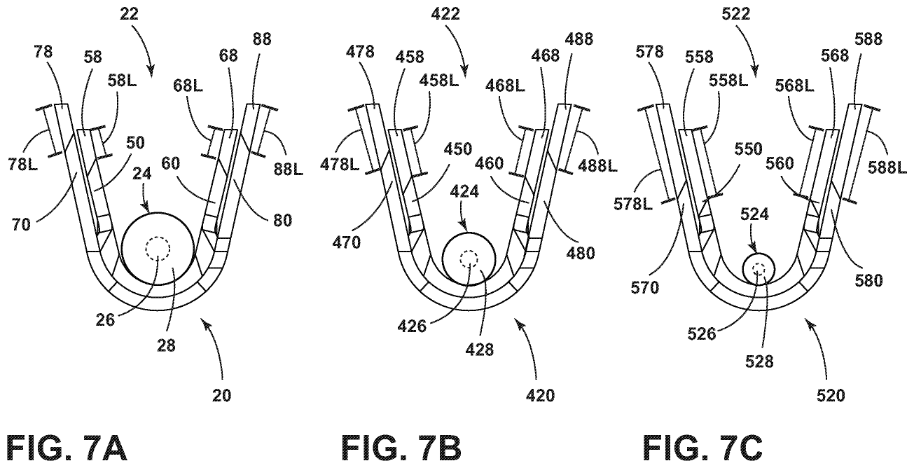

In embodiments, such as generally illustrated in FIGS. 1A, 1B, 1C, 1D, 1E, and 1F, a terminal assembly 22 may include a terminal 20 and a wire 24. The terminal 20 may include and/or be connected to a receiving portion 30. The receiving portion 30 may be configured to receive a male terminal or pin 32. The wire 24 may include a conductor 26 and an insulator 28 (e.g., see FIGS. 7A, 7B, and 7C). The insulator 28 may be connected to and/or at least partially surround the conductor 26. With embodiments, the terminal 20 may be configured to retain and/or electrically connect with a wire 24. The terminal 20 may include a terminal body portion 40, a first wing 50, and/or a second wing 60. A terminal 20 may include one or more of a variety of shapes, sizes, and/or configurations. For example and without limitation, the terminal 20 may be substantially U-shaped and/or V-shaped.

In embodiments, a terminal body portion 40, a first wing 50, and/or a second wing 60 may each include an inner surface and an outer surface. The terminal wings 50, 60 may be substantially planar. With embodiments, the terminal 20 may include a third wing 70 and/or a fourth wing 80. The first wing 50, the second wing 60, the third wing 70, and/or the fourth wing 80 may extend outward (e.g., vertically and/or laterally) from the terminal body portion 40. The first wing 50, the second wing 60, the third wing 70, and/or the fourth wing 80 may or may not extend at substantially the same angle (e.g., oblique and/or right angles) from the terminal body 40. The first wing 50 and the second wing 60 may extend at the same angle in opposite directions relative to the vertical direction.

With embodiments, the first wing 50 and the third wing 70 may extend from a first side 90 of the terminal body portion 40, and/or the second wing 60 and the fourth wing 80 may extend from a second side 92 of the terminal body portion 40. In embodiments, the first wing 50 and the second wing 60 may be disposed opposite each other, and/or the third wing 70 and the fourth wing 80 may be disposed opposite each other. With embodiments, such as generally illustrated in FIG. 1D, the first wing 50 and the second wing 60 may include lengths 50L, 60L (e.g., from a bottom of the wings to the top of the wings), which may or may not be the same. The third wing 70 and the fourth wing 80 may include lengths 70L, 80L, which may or may not be the same. The lengths 50L, 60L may be different than the lengths 70L, 80L (e.g., shorter or longer). In embodiments, such as generally illustrated in FIG. 1C, the first wing 50 and the second wing 60 may include widths 50W, 60W (e.g., relative to a longitudinal direction L), which may or may not be the same.

In embodiments, such as generally illustrated in FIG. 1C, the third wing 70 and/or the fourth wing 80 may be offset (e.g., not disposed directly across from each other). For example and without limitation, the third wing 70 may be disposed farther from the first wing 50 and/or the second wing 60 than the fourth wing 80. With embodiments, there may be a gap 94 (e.g., in the longitudinal direction L) between the third wing 70 and the fourth wing 80.

With embodiments, such as generally illustrated in FIGS. 1A-1D, the terminal body portion 40, the first wing 50, and/or the second wing 60 may form a first channel 96. The terminal body portion 40, the third wing 70, and/or the fourth wing 80 may form a second channel 98. With embodiments, the first channel 96 and/or the second channel 98 may be aligned (e.g., aligned in the longitudinal direction L and/or the lateral/transverse direction T). The first wing 50 and the second wing 60 may be configured to retain a conductor 26 of a wire 24. The third wing 70 and the fourth wing 80 may be configured to retain an insulator 28 of a wire 24.

In embodiments, the first channel 96 may include a width 96W and the second channel 98 may include a width 98W (e.g., width in a lateral direction T of the terminal 20). The first channel width 96W may be less than the second channel width 98W in at least some areas. With embodiments, the first channel 96 may include a first height 96H (e.g., in the vertical direction V), and the second channel may include a second height 98H (e.g., in the vertical direction). The second height 98H may be greater than the first height 96H, such as when measured from the same vertical position of the terminal 20 (e.g., at or about end portions 58, 68, 78, 88 of the wings 50, 60, 70, 80).

In embodiments, the wings 50, 60, 70, 80 may each include a connecting portion 54, 64, 74, 84, a middle portion 56, 66, 76, 86, and/or an end portion 58, 68, 78, 88. The connecting portion 54, 64, 74, 84 may connect the wings 50, 60, 70, 80 to the terminal body 40. The middle portion 56, 66, 76, 86 of the wings 50, 60, 70, 80 may connect the connecting portions 54, 64, 74, 84 to the end portions 58, 68, 78, 88.

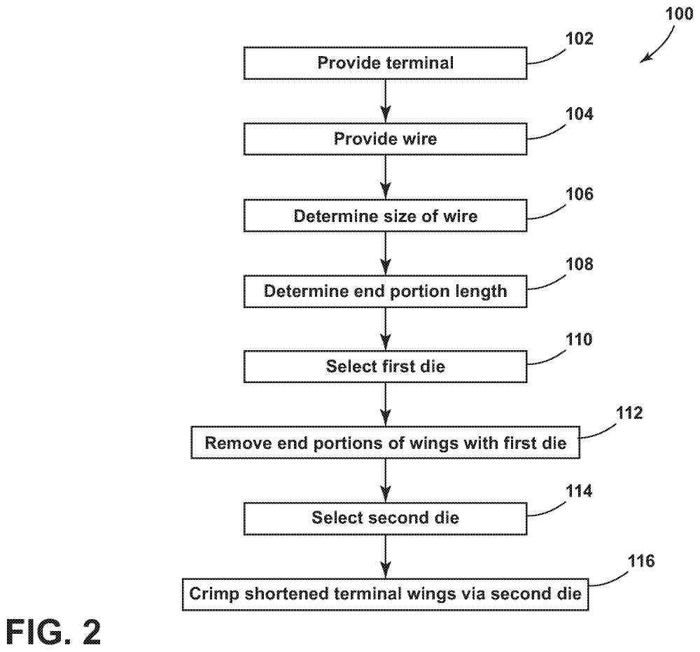

In embodiments, such as generally illustrated in FIG. 2, a method 100 of assembling a terminal assembly 22 may include providing a terminal 20 (step 102), providing a wire 24 (step 104), and/or determining the size of the wire 24 (step 106). The method may include determining an end portion length (step 108). The end portion length may correspond to an length of the wing to be removed and may be determined according to the size of the wire, such as determined in step 106. For example and without limitation, for smaller wires, a larger end portion length may be determined and/or, for larger wires, a smaller end portion length may be determined. With some larger wires, the determined end portion length may be substantially zero, and the method 100 may proceed to selecting a second die (step 114). For many wires, the method 100 may continue with selecting a first/removing die 130 (step 110). The first die 130 may be selected according to the determined end portion length. For example and without limitation, the first die may be configured to remove end portions of certain lengths.

With embodiments, the method 100 may include removing an end portion 58, 68, 78, 88 of one or more of the terminal wings 50, 60, 70, 80 via the first die 130 (step 112), which may provide shortened versions of wings 50, 60, 70, 80. The method 100 may include selecting a second/crimping die 170 (step 114). The second die 170 may be selected according to the determined end portion length or the same second die 170 may be used for many end portion lengths. The method 100 may include crimping one or more of the shortened wings 50, 60, 70, 80 via the second die 170 (step 116). Crimping one or more of the terminal wings 50, 60, 70, 80 may include crimping the first wing 50 and the second wing 60 with a conductor 26 of the wire 24 and/or crimping the third wing 60 and the fourth wing 80 with the insulator 28 of the wire.

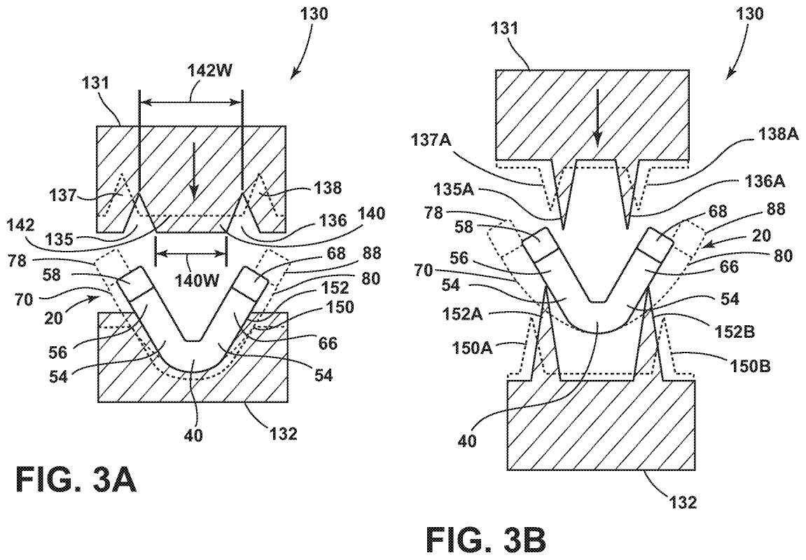

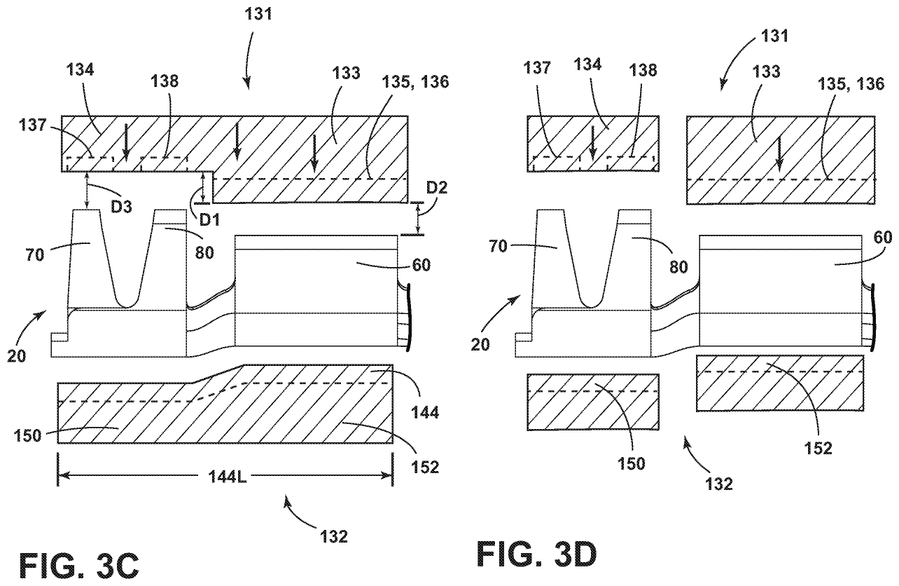

In embodiments, the terminal 20 may include a first state, a second state, and/or a third state. In the first state, the terminal 20 may not be crimped, shortened, altered, and/or bent (see, e.g., FIGS. 1A-1F). In the second state, at least a portion of the terminal 20 may be removed (see, e.g., FIGS. 3C-5A). For example and without limitation, one or more of the end portions 58, 68, 78, 88 of the first wing 50, the second wing 60, the third wing 70, and/or the fourth wing 80 may be removed by the first/removing die 130. In the third state, the terminal 20 may be crimped onto/with a wire 24 (see, e.g., FIGS. 7A-7C). In embodiments, a first die 130 may be configured to remove a portion of the terminal 20. The terminal 20 may transition from the first state to the second state via the first die 130. A second die 170 may crimp the terminal 20. With embodiments, the terminal 20 may transition from the second state to the third state via the second die 170.

With embodiments, after removing a portion of the wings 50, 60, 70, 80, the first channel 96 and/or the second channel 98 may remain substantially open. The channels 96, 98 may be substantially open so that a wire 24 may be inserted (e.g., vertically from above the terminal 20 or longitudinally) into the first and/or second channel 96, 98. After removing a portion of the wings 50, 60, 70, 80, the wings may project from the terminal body portion 40 at substantially the same angle as before removing.

In embodiments, such as generally illustrated in FIGS. 3A, 3B, 3C, and 3D, removing a portion of the terminal 20 may include removing a portion of a terminal 20 via a first die 130 (e.g., a removing/cutting die). The first die 130 may include a top portion 131 and a bottom portion 132. The top portion 131 may be disposed substantially parallel to the bottom portion 132.

With embodiments, prior to removal, the top portion 131 may be disposed proximate the end portions 58, 68, 78, 88 of the wings 50, 60, 70, 80. The bottom portion 132 may be disposed proximate the terminal body portion 40 and/or the connecting portions 54, 64, 74, 84 of the wings 50, 60, 70, 80. In embodiments, the top portion 131 of the first die 130 may include a conductor removing portion 133 and an insulator removing portion 134 (see, e.g., FIGS. 3C and 3D). As generally illustrated in FIG. 3C, the conductor removing portion 133 may be formed with the insulator removing portion 134 as a single piece. Alternatively, as generally illustrated in FIG. 3D, the conductor removing portion 133 may be independent from the insulator removing portion 134 (e.g., the conductor removing portion 133 and the insulator removing portion may be separate pieces that may be independently movable). In embodiments, the conductor removing portion 133 may be configured to remove the end portion 58 of the first wing 50 and/or the end portion 68 of the second wing 60. The insulator removing portion 134 may be configured to remove the end portion 76 of the third wing 70 and/or the end portion 88 of the fourth wing 80. The conductor removing portion 133 may be vertically offset by a distance D₁ from the insulator removing portion 134, such as to compensate for different heights of the first wing 50 and the second wing 60 relative to the third wing 70 and the fourth wing 80. In an initial/non-removing position, a conductor removing portion 133 may be disposed at a distance D₂ from the first wing 50 and/or the second wing 60. In an initial/non-removing position, the insulator removing portion 134 may be disposed at a distance D₃ from the third wing 70 and/or fourth wing 80. Distances D₂, D₃ may be substantially the same.

With embodiments, a first die top portion 131 may include a first recess 135 and/or a second recess 136. In embodiments, the first recess 135 and/or a second recess 136 may receive at least a portion of the wings 50, 60, 70, 80. The first recess 135 and/or the second recess 136 may include one or more of a variety of shapes, sizes, and/or configurations. For example and without limitation, the first recess 135 and/or a second recess 136 may be substantially triangular, rectangular, oval-shaped and/or generally rounded. A first recess 135 and/or a second recess 136 may open downward and/or to a side of the first die 130. In embodiments, the first recess 135 and the second recess 136 may be configured to remove the end portions 58, 68 of the wings 50, 60.

In embodiments, the first die top portion 131 may include a third recess 137 and/or a fourth recess 138. The third recess 137 and the fourth recess 138 may be configured to remove the end portions 78, 88 of the wings 70, 80. With embodiments, the first recess 135 may contact the first wing 50, the second recess 136 may contact the second wing 60, the third recess 137 may contact the third wing 70, and/or the fourth recess 138 may contact the fourth wing 80 (e.g., simultaneously). The recesses 135, 136, 137, 138 may be substantially similar or the same shape and/or size. The first and second recesses 135, 136 disposed lower than the third and fourth recesses 137, 138. In embodiments, the first recess 135 and the second recess 136 may be disposed at a different distance from the terminal body portion 40 than the third recess 137 and the fourth recess 138. In embodiments, the first recess 135 and/or the second recess 136 may be formed into the same side (e.g., bottom side) of the top portion 131.

With embodiments, a top portion 131 of a first die 130 may include a first bridge portion 140 and/or a second bridge portion 142. The bridge portions 140, 142 may include one or more of a variety of shapes, sizes, and/or configurations. For example and without limitation, the bridge portions 140, 142 may have a substantially flat/planar bottom surface that may include a rectangular configuration or the bottom surface may be substantially pointed. With embodiments, the bridge portions 140, 142 may be disposed between (e.g., laterally) recesses 135, 136, and recesses 137, 138, respectively. The bridge portions 140, 142 may limit movement of the wings 50, 60, 70, 80 towards each other and/or the center of the terminal body portion 40 during removing, such as to facilitate insertion of a wire 24 into the first channel 96 and/or the second channel 98 after bending and prior to crimping. The bridge portions 140, 142 may support the wings 50, 60, 70, 80 during removal such that the wings 50, 60, 70, 80 remain at substantially the angle before and after removing. Additionally or alternatively, the bridge portions 140, 142 (e.g., edges of the bridge portions 140, 142) may cut into the wings 50, 60, 70, 80, and may remove one or more end portions 58, 68, 78, 88.

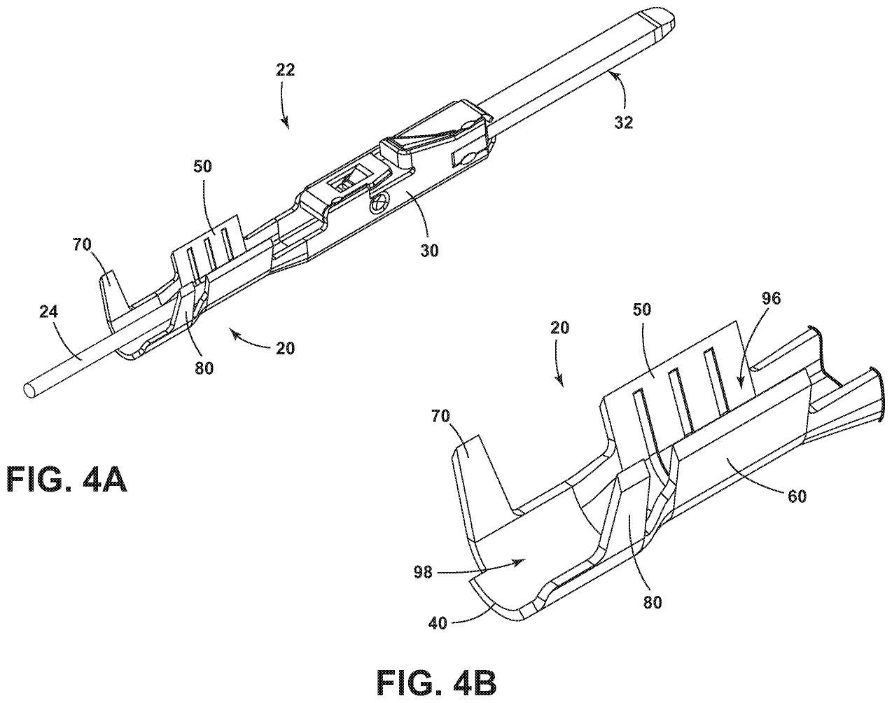

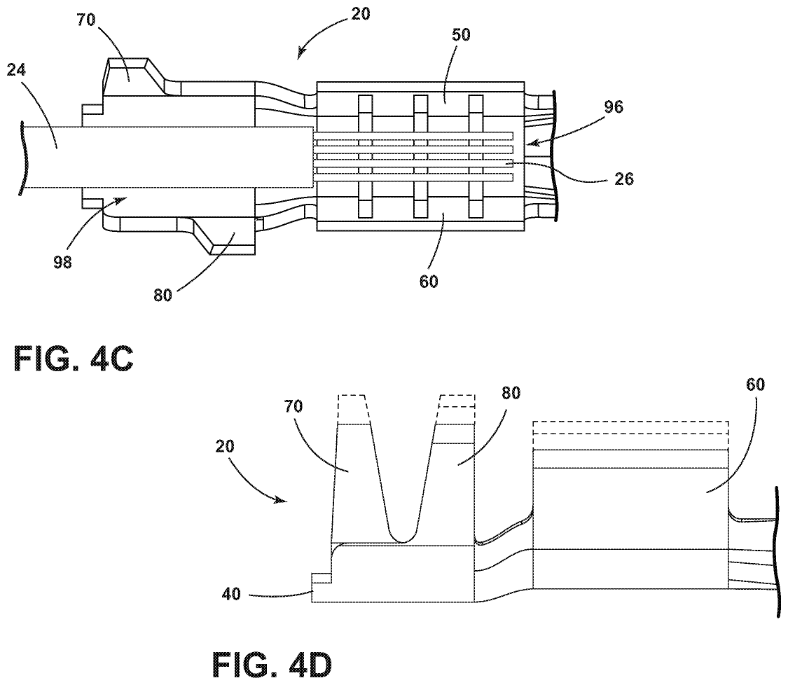

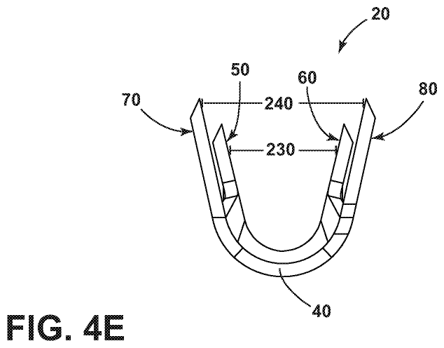

In embodiments, the first bridge portion 140 may include a width 140W (e.g., in a lateral direction) that may be less than a width 142W (e.g., in a lateral direction) of the second bridge portion 142. For example and without limitation, the widths 140W, 142W of the bridges 140, 142 may correspond to sizes of gaps 230, 240 between the wings 50, 60, and the wing 70, 80, respectively (e.g., see FIG. 4E). The first gap 230 may be between the first wing 50 and the second wing 60. The second gap 240 may be between the third wing 70 and the fourth wing 80. Greater widths 140W, 142W of the bridges 140, 142 may correlate to larger gaps 230, 240, and/or smaller widths 140W, 142W of the bridges 140, 142 may correlate to smaller gaps 230, 240.

In embodiments, the first die bottom portion 132 may include a channel 144. The channel 144 may include one or more of a variety of shapes, sizes, and/or configurations. For example and without limitation, the channel 144 may be substantially U-shaped, V-shaped, oval-shaped, and/or rounded. In embodiments, the channel 144 may retain a terminal 20 during bending. For example and without limitation, the channel 144 may retain the terminal body portion 40, at least some parts of one or more of the wing connecting portions 54, 64, 74, 84, and/or at least some parts of the middle portions 56, 66, 76, 86. The channel 144 may extend in a longitudinal direction, such as from a first end of the bottom portion 132 to a second end of the bottom portion 132. The first end may be opposite the second end. The channel 144 may include a length 144L (e.g., in the longitudinal direction) that may be longer or shorter than the terminal 20, or the length 144L may be substantially the same as a length of the terminal 20.

In embodiments, the channel 144 may include an insulator portion 150 and/or a conductor portion 152. The insulator portion 150 may be wider than the conductor portion 152. In embodiments, the insulator portion 150 may be configured to retain (e.g., restrict movement in at least one direction) the terminal body portion 40 at or about the third wing 70 and the fourth wing 80. The conductor portion 152 may be configured to retain the terminal body portion 40 at or about the first wing 50 and the second wing 60. With embodiments, such as generally illustrated in FIG. 3A, in an initial/pre-bending position of the terminal 20, the channel 144 may be configured such that the terminal 20 contacts an inner surface of the channel 144 (e.g., substantially all of the inner surface). In other embodiments, such as generally illustrated in FIG. 3B, the channel 144 may be configured such that the terminal 20 contacts the channel 144 substantially along edges of the channel 144 (e.g., upper edges).

In embodiments, such as generally illustrated in FIG. 3B, the first die top portion 131 may include protrusions 135A, 136A, 137A, 138A (e.g., instead of recesses 135, 136, 137, 138). The protrusions 135A, 136A, 137A, 138A may include one or more of a variety of shapes, sizes, and/or configurations. For example and without limitation, the protrusions 135A, 136A, 137A, 138A may have a substantially pointed and/or sharp bottom. The protrusions 135A, 136A, 137A, 138A may be substantially triangular. The first and second protrusions 135A, 136A may be configured to contact the first wing 50 and the second wing 60. The third and fourth protrusions 137A, 138A may be configured to contact the third wing 70 and the fourth wing 80 respectively. The distance between the first and second protrusions 135A, 136A may be less than the distance between the third and fourth protrusions 137A, 138A. In embodiments, the first and second protrusions 135A, 136A may extend farther from the top portion 131 than the third and fourth protrusions 137A, 138A such as to make contact with the correlating wings at substantially the same time during removing.

In embodiments, such as generally illustrated in FIG. 3B, the channel 144 may be formed via one or more protrusions 150A, 150B, 152A, 152B. The protrusions 150A, 150B, 152A, 152B may include one or more of a variety of shapes, sizes, and/or configurations. For example and without limitation, the protrusions 150A, 150B, 152A, 152B may be substantially triangular, rectangular, pointes, and/or sharp. The protrusions 150A, 150B, 152A, 152B may retain (e.g., limit movement in at least one direction) the terminal body portion 40, at least some parts of one or more of the wing connecting portions 54, 64, 74, 84, and/or at least some parts of the middle portions 56, 66, 76, 86, such as during removal. The protrusions 150A, 150B, 152A, 152B may extend in a vertical direction.

With embodiments, the first and and/or second protrusions 150A, 150B may be configured to contact the first wing 50 and/or the second wing 60, such as to remove the first end portion 58 and/or the second end portion 68. The third and/or fourth protrusions 152A, 152B may be configured to contact the third wing 70 and/or the fourth wing 80, such as to remove the third end portion 78 and/or the fourth end portion 88. The distance between the first and second protrusions 150A, 150B may be less than the distance between the third and fourth protrusions 152A, 152B. In embodiments, the first and second protrusions 150A, 150B may extend farther from the bottom portions 132 than the third and fourth protrusions 152A, 152B, such as to make contact with the correlating wings at substantially the same time during removing (e.g., end portions 58, 68, 78, and/or 88 may be removed at substantially the same time).

With embodiments, the protrusions 135A, 136A, 137A, 138A cooperate with the protrusions 150A, 150B, 152A, 152B and/or may be configured to remove (e.g., cut off) end portions 58, 68, 78, 88 to provide shortened wings 50, 60, 70, 80.

In embodiments, such as generally illustrated in FIGS. 4A, 4B, 4C, 4D and 4E, in the second state, the terminal 20 may include shortened versions of the wings 50, 60, 70, 80. In the first state and the second state, the terminal 20 may be substantially similar and/or include similar features, except for the length of the wings 50, 60, 70, 80. As generally illustrated in FIG. 4D, the terminal wings 50, 60, 70, 80 may be shorter (see, e.g., removed portions are represented by the dashed lines) after removal (e.g., step 112 of method 100).

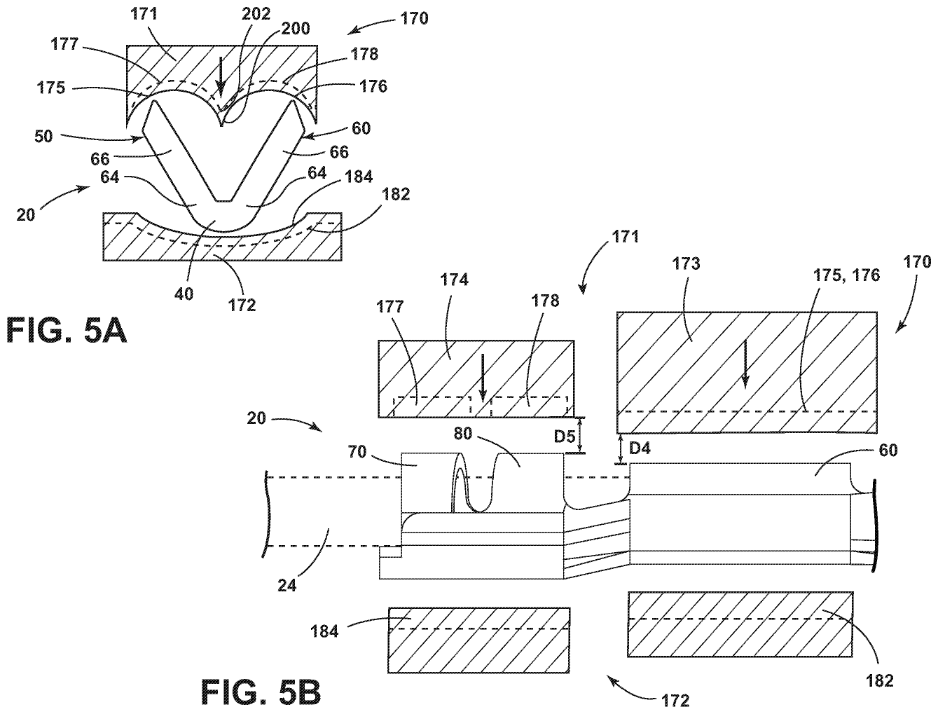

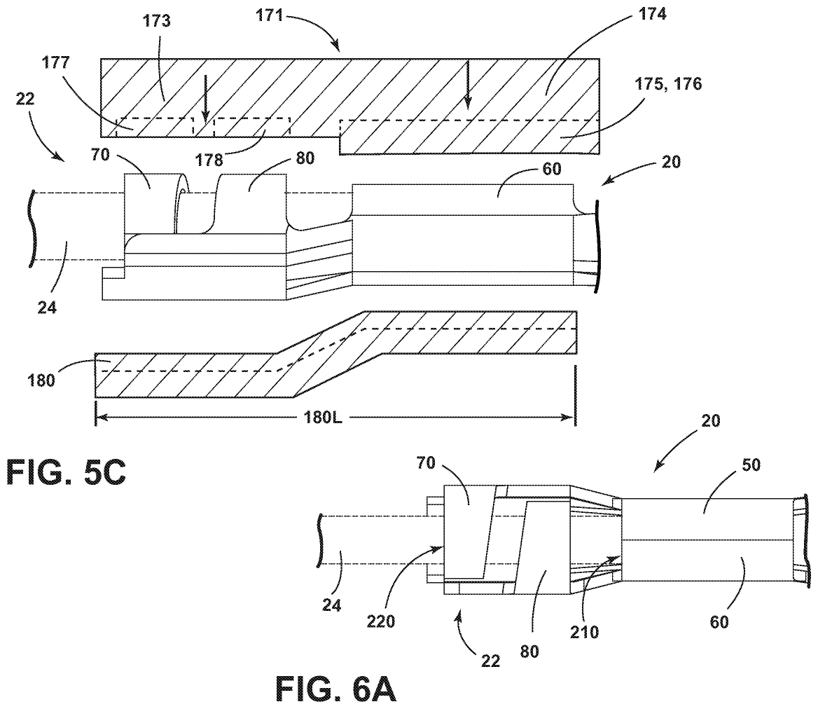

In embodiments, a third state of the terminal 20 may include the terminal 20 being crimped with a wire or cable, such as after a portion is removed from the wings 50, 60, 70, 80. The terminal 20 may be crimped with a wire 24 via a second die 170 (see, e.g., FIG. 5A). The second die 170 may include a top portion 171 and a bottom portion 172. The top portion 171 may be disposed substantially parallel to the bottom portion 172.

With embodiments, such as generally illustrated in FIGS. 5A, 5B, and 5C, the top portion 171 may be disposed proximate the ends of the wings 50, 60, 70, 80 (e.g., ends of the middle portions 56, 66, 76, 86), such as prior to crimping. The bottom portion 172 may be disposed proximate the terminal body portion 40 and/or the connecting portions 54, 64, 74, 84 of the wings 50, 60, 70, 80. In embodiments, the top portion 171 may include a conductor crimp portion 173 and an insulator crimp portion 174. The conductor crimp portion 173 may be formed with the insulator crimp portion 174 as a single piece. Alternatively, the conductor crimp portion 173 may be independent from the insulator crimp portion 174 (e.g., may be separate, independently movable pieces). The conductor crimp portion 173 may be disposed proximate the shortened first wing 50 and second wing 60. The insulator crimp portion 174 may be disposed proximate the shortened third wing 70 and fourth wing 80, such as prior to crimping. A conductor crimp portion 173 may be disposed at a distance D₄ from the end of the shortened first wing 50 and the second wing 60 and, and the insulator crimp portion 174 may be disposed at a distance D₅ from the end of the shortened third wing 70 and fourth wing 80 (see, e.g., FIG. 5B). Distances D₄, D₅ may or may not be substantially the same. For example and without limitation, the wings 50, 60, 70, 80 may be crimped at substantially the same time (e.g., simultaneously).

With embodiments, the conductor crimp portion 173 may include a first recess 175, and/or a second recess 176. The conductor crimp portion 173 may include a first protrusion 200 between the first recess 175 and the second recess 176. The insulator crimp portion 174 may include a third recess 177 and/or a fourth recess 178. The insulator crimp portion 174 may include a second protrusion 202 that may be disposed between the third recess and the fourth recess. The first protrusion 200 and the second protrusion 202 may include one or more of a variety of shapes, sizes, and/or configuration. For example and without limitation, the first and second protrusions 200, 202 may be substantially triangular and/or pointed.

In embodiments, the recesses 175, 176, 177, 178 may include one or more of a variety of shapes, sizes, and/or configurations. For example and without limitation, the recesses 175, 176, 177, 178 may be substantially oval-shaped, half circle-shaped, and/or generally rounded. The recesses 175, 176, 177, 178 may be substantially similar and may include substantially the same shape and/or size. In embodiments, the first recess 175 and the second recess 176 may be disposed at a different distance from the terminal body portion 40 (e.g., at a different height) than the third recess 177 and the fourth recess 178, such as to compensate for different heights of the shortened first wing 50 and second wing 60 relative to the shortened third wing 70 and fourth wing 80. The first recess 175 and the second recess 176 may be disposed at the same distance from ends of the shortened first and second wings 50, 60 as the third recess 177 and the fourth recess 178 may be disposed from ends of the shortened third and fourth wings 70, 80.

In embodiments, such as generally illustrated in FIGS. 5A, 5B, and 5C, the second die bottom portion 172 may include a channel 180. The channel 180 may include one or more of a variety of shapes, sizes, and/or configurations. For example and without limitation, the channel 180 may be substantially U-shaped, V-shaped, oval-shaped, and/or rounded. In embodiments, the channel 180 may retain a terminal 20 during crimping. For example and without limitation, the channel 180 may retain (e.g., limit movement in at least one direction) the terminal body portion 40 and/or the connecting portions 54, 64, 74, 84 of the first wing 50, second wing 60, third wing 70, and fourth wing 80. The channel 180 may extend in a longitudinal direction, such as from a first end of the bottom portion 172 to a second end of the bottom portion 172. The first end may be opposite the second end. The channel 180 may include a length 180L (e.g., in the longitudinal direction) that may be longer or shorter than the terminal 20, or the length 180L may be substantially the same as a length of the terminal 20.

In embodiments, the channel 180 may include an insulator portion 182 and/or a conductor portion 184. The conductor portion 184 may be wider than the insulator portion 182. In embodiments, the insulator portion 182 may be configured to retain (e.g., restrict movement in at least one direction) the terminal body portion 40 at or about the third wing 70 and the fourth wing 80. The conductor portion 184 may be configured to retain the terminal body portion 40 at or about the first wing 50 and the second wing 60. With embodiments, such as generally illustrated in FIG. 5A, in an initial/pre-crimping position of the terminal 20, the channel 180 may be configured to contact the terminal 20 along an inner surface of the channel 180 (e.g., substantially all of the inner surface). In other embodiments, the channel 180 may be wider than the terminal 20 and the terminal may contact only portions of the inner surface of the channel 180.

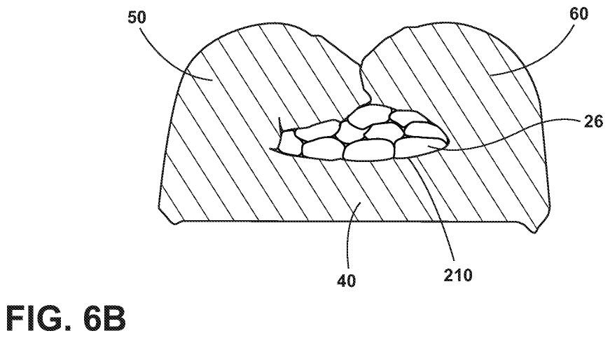

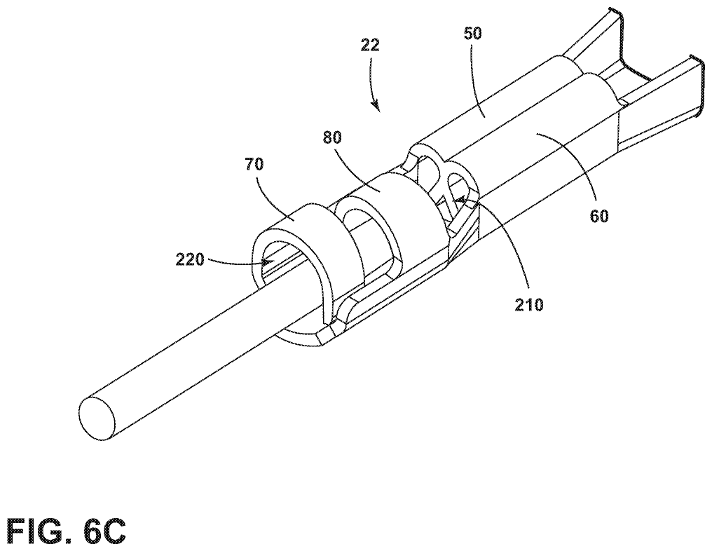

With embodiments, such as generally illustrated in FIGS. 6A, 6B, and 6C, in a third state of a terminal 20, an end of the first wing 50 may be in contact with an end of the second wing 60. An end of the third wing 70 may or may not be in contact with an end of the fourth wing 80. The third wing 70 and the fourth wing 80 may be offset longitudinally as to not contact each other in the third state.

In embodiments, a terminal 20 in a third state may include a channel 210 to retain a conductor 26 of a wire. The channel 210 may be substantially closed and/or may be formed, at least in part, from the shortened first wing 50 and/or the shortened second wing 60. The channel 210 may include one or more of a variety of shapes, sizes, and/or configurations. For example and without limitation, the channel 210 may be substantially triangular, circular, rectangular, or oval-shaped. In embodiments, the first wing 50 and the second wing 60 may be shortened enough during removing (step 112) such that when crimped (step 116) the ends of the first wing 50 and the second wing 60 contact each other (see, e.g., FIG. 6B). The first and second wings 50, 60 may be crimped such that the wings 50, 60 may or may not fold downward (e.g., the wings may extend substantially horizontal and/or parallel to the terminal body portion 40). In embodiments, the conductor 26 may contact an inner surface of the wings 50, 60, and/or the conductor 26 may contact an inner surface of the terminal body portion 40, which may provide an electrical connection between the conductor 26 and the terminal 20.

In embodiments, such as generally illustrated in FIGS. 6A and 6C, a terminal 20 in a third state may include a channel 220 to retain an insulator 28 of a wire 24. The channel 220 may be formed by the terminal body portion 40, the shortened third wing 70, and/or the shortened fourth wing 80. The terminal body portion 40, connecting portions 74, 84, and/or middle portions 76, 86, of the third wing 70 and/or the fourth wing 80 may contact the insulator 28. The channel 210 retaining the conductor 26 may be aligned with the channel 220 retaining the insulator 28.

With embodiments, such as generally illustrated in FIGS. 7A, a first terminal assembly 22 may include a first terminal 20 and a wire 24. The first terminal 20 may include a first wing 50, a second wing 60, a third wing 70, and/or a fourth wing 80. The wings 50, 60, 70, 80 may include end portions 58, 68, 78, 88, respectively. End portions 58, 68, 78, 88 may include lengths 58L, 68L, 78L, 88L. As generally illustrated in FIG. 7B, a second terminal assembly 422 may include a second terminal 420 and a second wire 424. The second terminal 420 may include a first wing 450, a second wing 460, a third wing 470, and/or a fourth wing 480. The wings 450, 460, 470, 480 may include end portions 458, 468, 478, 488, respectively. End portions 458, 468, 478, 488 may include lengths 458L, 468L, 478L, 488L.

As generally illustrated in FIG. 7C, a third terminal assembly 522 may include a third terminal 520 and a third wire 524. The third terminal 520 may include a first wing 550, a second wing 560, a third wing 570, and/or a fourth wing 580. The wings 550, 560, 570, 580 may include end portions 558, 568, 578, 588, respectively. End portions 558, 568, 578, 588 may include lengths 558L, 568L, 578L, 588L.

The wires 24, 424, 524 may include respective conductors 26, 426, 526 and/or insulators 28, 428, 528. In embodiments, a diameter of the wire 24 may be greater than a diameter of the second wire 424 and the third wire 524. A diameter of the second wire 424 may be greater than a diameter of the third wire 524 (e.g., each of the wires may have a different diameter). In the first state (before removing a portion of the wings), the terminal assemblies 22, 422, 522 may be substantially the same.

With embodiments, a method 100 of assembling terminal assemblies may be different depending on the size of the wire with which a terminal assembly will be crimped. For example and without limitation, in step 106, the size of the wires 24, 424, 524 may be determined. Wire 24 may be relatively large, so the lengths 58L, 68L, 78L, 88L of the end portions 58, 68, 78, 88 may be determined, such as in step 108, to be relatively short (e.g., to leave relatively long wings after removal). Wire 424 may be smaller than wire 24, so the lengths 458L, 468L, 478L, 488L of end portions 458, 468, 478, 488 may be determined, in step 108, to be longer than lengths 58L, 68L, 78L, 88L. Wire 524 may be smaller than wires 24, 424, so the lengths 558L, 568L, 578L, 588L of end portions 558, 568, 578, 588 may be determined, in step 108, to be longer than lengths 458L, 468L, 478L, 488L (e.g., to leave relatively short wings after removal). After removal (step 112), each of the terminals 20, 420, 520 may include different configurations and may be crimped to wires of different sizes (e.g., wires 24, 424, 524).

Removing portions of terminals 20, 420, 520 may permit use of terminals of the same original configuration (pre-removal and pre-crimping) with wires/cables of a wide variety of sizes while maintaining sufficient final crimp quality.

Various embodiments are described herein for various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments.

Reference throughout the specification to “various embodiments,” “with embodiments,” “in embodiments,” or “an embodiment,” or the like, means that a particular feature, structure, or characteristic described in connection with the embodiment is included in at least one embodiment. Thus, appearances of the phrases “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of embodiments.

Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. The use of “e.g.” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are intended to be inclusive unless such a construction would be illogical.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

It is intended that all matter contained in the above description or shown in the accompanying drawings shall be interpreted as illustrative only and not limiting. Changes in detail or structure may be made without departing from the present disclosure.

What is claimed is:

1. A method of assembling a terminal assembly, the method comprising:
providing a terminal, the terminal including a terminal body, a first wing, and a second wing;
removing an end portion of the first wing and an end portion of the second wing to provide a shortened first wing and a shortened second wing; and
crimping the shortened first wing and the shortened second wing onto a wire.

2. The method of claim 1, wherein the end portion of the first wing and the end portion of the second wing are removed simultaneously.

3. The method of claim 2, wherein the end portion of the first wing and the end portion of the second wing are removed via a die.

4. The method of claim 3, wherein the die includes a first protrusion that contacts an inner surface of the first wing during the removing and includes a second protrusion that contacts an inner surface of the second wing during the removing.

5. The method of claim 1, including removing an end portion of a third wing of the terminal and removing an end portion of a fourth wing of the terminal.

6. The method of claim 5, wherein the end portion of the first wing, the second wing, the third wing, and the fourth wing are removed simultaneously.

7. The method of claim 5, wherein, initially, the third wing and the fourth wing are longer than the first wing and the second wing.

8. The method of claim 1, including determining a size of the wire; and determining lengths of the end portion of the first wing and the end portion of the second wing according to the size of the wire.

9. The method of claim 1, including
providing a second terminal having a terminal body, a first wing, and a second wing, and
removing an end portion of the first wing of the second terminal to provide a shortened first wing of the second terminal; and
removing an end portion of the second wing of the second terminal to provide a shortened second wing of the second terminal.

10. The method of claim 9, wherein before the removing of the end portion of the first wing and the second wing of the terminal and before the removing of the end portion of the first wing and the second wing of the second terminal, the terminal and the second terminal are substantially the same.

11. The method of claim 10, wherein lengths of the shortened first wing and the shortened second wing of the terminal are different than lengths of the shortened first wing and the shortened second wing of the second terminal.

12. The method of claim 10, wherein lengths of the end portion of the first wing and the second wing of the terminal are different than lengths of the end portion of the first wing and the second wing of the second terminal.

13. The method of claim 10, including crimping the shortened first wing and the shortened second wing of the second terminal onto a second wire.

14. The method of claim 13, wherein the second wire includes a different diameter than the wire.

15. The method of claim 13, including determining a size of the second wire; and
determining lengths of the end portion of the first wing and the second wing of the second terminal according to the size of the second wire.

16. The method of claim 1, wherein the end portion of the first wing and the end portion of the second wing are removed via a first die.

17. The method of claim 16, wherein the first die includes a first portion and a second portion, and, during the removing, the first portion contacts the first wing and the second wing, and the second portion contacts a third wing and a fourth wing of the terminal.

18. The method of claim 17, wherein the first portion is disposed at a different vertical height than the second portion.

19. The method of claim 16, wherein the shortened first wing and the shortened second wing are crimped via a second die.

20. The method of claim 19, wherein the first die and the second die include different configurations.
